(19) United States
(12) Patent Application Publication
(10) Pub. No.: US 2025/0388750 A1
(43) Pub. Date: Dec. 25, 2025

(54) POLYMER COMPOSITION FOR LASER MARKING

(71) Applicant: MERCK PATENT GMBH, Darmstadt (DE)

(72) Inventors: Ulrich QUITTMANN, Darmstadt (DE); Hans-Juergen BREHM, Darmstadt (DE)

(73) Assignee: MERCK PATENT GMBH, Darmstadt (DE)

(21) Appl. No.: 18/996,921

(22) PCT Filed: Jul. 24, 2023
(86) PCT No.: PCT/EP2023/070389

§ 371 Date: Jan. 17, 2025

(30) Foreign Application Priority Data
Jul. 26, 2022 (EP) 22186952.2

(51) Int. Cl. C08L 77/02; B23K 26/70; C08J 3/18; C08J 3/20; C08J 3/22; C08K 3/013; C08K 3/014; C08K 3/22

(52) U.S. Cl. CPC C08L 77/02; B23K 26/702; C08J 3/18; C08J 3/203; C08J 3/226; C08K 3/013; C08K 3/014; C08K 3/22; C08J 2377/02; C08J 2477/02; C08J 2481/02; C08K 2003/2241; C08L 2205/025; C08L 2205/03

(57) ABSTRACT

The invention relates to a polymer composition comprising a polyamide or polyester carrier polymer matrix in which special polymer particles are embedded, to a process for the preparation of this polymer composition, to the use thereof as laser inscription additive or laser welding additive in organic polymer compositions, and to a laser-inscribable or laser-weldable organic polymer composition comprising this polymer composition.

### TECHNICAL FIELD

The invention relates to a polymer composition comprising a polyamide or polyester carrier polymer matrix in which special polymer particles are embedded, to a process for the preparation of this polymer composition, to the use thereof as laser inscription additive or laser welding additive in organic polymer compositions, and to a laser-inscribable or laser-weldable organic polymer composition comprising this polymer composition.

### PRIOR ART

The labelling of plastic products is a topic that has been current for a long time and is constantly growing in importance. Although classical labelling processes, such as printing, application of adhesive labels or embossing of intermediate or final products, continue to be carried out, they are more complex in terms of the process and often have disadvantages in relation to the durability of the label.

The laser inscription of plastic products has also been carried out for some time. This can be effected without contact during the running production process, results in durable inscriptions, without consumable material for the actual inscription and reduces the production of waste and system downtime. In this respect, laser inscription has clear material and technical advantages compared with traditional labelling methods. Laser markings are very durable. Adhesion problems, as in the case of adhesive labels and direct printing processes, do not arise due to the fact that the laser marking takes place in the material.

Pale or dark laser markings on plastics can be produced by various reactions in the plastics.

Either the organic matrix of the plastic itself or an added laser additive can absorb the laser radiation, with the energy thereby released to the plastic leading to foaming or carbonisation of the plastic. In addition, laser additives present in the plastic can also react intrinsically to laser radiation and generate their colour under the influence of radiated laser energy, for example by darkening.

While very few plastics react very well to laser radiation without further additives, most types of plastic often show only weak or no markings or only react to a small extent to laser radiation of certain wavelengths.

For example, polyamide grades without correspondingly added laser additives are virtually impossible to inscribe with good contrast using conventional laser equipment, as their chemical nature often only produces pale marks. Polyamide usually tends to foam when laser marked. Technical applications mainly use Nd:YAG lasers or fibre lasers, which emit at wavelengths of 1064 nm or 1062-1070 nm. Markings caused by these lasers do not meet the requirements of the market.

In the case of polyesters too, there are also market-side requirements to produce better dark markings. This requirement is mainly a result of the use of flame retardants, e.g. in compounds in electrical and electronic applications. Flame retardants likewise lead to strong foaming and thus prevent dark marking.

U.S. Pat. No. 3,839,064 describes polymeric microcapsule systems consisting of discrete spherical particles, each of which has a polymer core with inorganic particles dispersed therein and a solid polymer shell around the polymer core. These particles have high opacity and modifiable gloss and are employed, in particular, as colourants in fibre-containing products. The core of the microcapsules preferably consists of polystyrene, in which inorganic particles, such as titanium dioxide, barium sulfate, calcium carbonate or carbon black, can be dispersed. The solid shell preferably consists of a hydroxylated polymer, such as methylcellulose, polyvinyl alcohol or gelatine. Polyamides can likewise be used as the shell material. Whether and to what extent fibre systems containing these particles react to laser radiation is not reported.

WO9530716 A1 describes moulding compositions based on thermoplastic or thermosetting plastics A) comprising 0.05 to 10 wt.-%, based on A), of a micropowder with spherical particles having a substantially smooth surface structure, which comprises as essential component at least one polymer B) which is different from A), selected from the group of polyphenylene ethers, polyarylene ether sulfones, polyarylene ether ketones or polyimides. Additives may optionally be present, for example bone ash or carbon black.

WO9858805 describes laser-markable plastics which are distinguished by the fact that a plastic that is difficult to treat by laser comprises an intrinsically laser-markable polymer in the form of microground particles having a particle size of 0.1 to 100 μm as absorber material. Example 3 describes the components polyamide 6 (99 parts) and 1 part of polyimide sulfone. Example 4 describes the components polyamide 6 (99.6 parts) and 0.4 part of polyphenylene sulfide. Example 6 describes the components of an unsaturated polyester resin (99 parts) and 1 part of polyphenylene sulfide, with co-octate and cyclohexanone peroxide present as additives. Example 8 describes a mixture of 96 parts of polyphenylene sulfide with 4 parts of basic copper phosphate, which can be incorporated into plastic in an amount of 0.4%, for example into polyamide.

WO2004050766 A1 discloses laser light-absorbent particles which have a first polymer with an absorber present therein as core, with a second polymer being attached to the surface of this core via functional groups, and the first and second polymers having functional groups which are different from one another. Preferably, three and optionally four types of polymer are employed. Antimony trioxide, tin dioxide, barium titanate, titanium dioxide, aluminium oxide, copper phosphate and anthraquinone or azo dyes are described as preferred absorbers. Polyamides and polyesters are described as preferred for the core. Suitable second polymers are polyolefin polymers carrying specific unsaturated functional groups.

WO09090057 proposes a process for the preparation of a laser-markable polymer material, in which a base polymer that is difficult to laser-mark and an intrinsically laser-markable sensitive polymer and optionally another polymer material are mixed, with none of the materials carrying any functional groups, this mixture is melted to form a masterbatch material, the masterbatch material is converted into a dilution mixture with a diluent polymer, and the dilution mixture forms a laser-markable polymer material with melting of the base polymer and diluent polymer. For example, polyamide 6 is mixed with polyphenylene sulfide, and antimony-doped tin oxide may also be incorporated.

WO2014206523 A1 describes microspheres which consist of a core-shell particle dispersed in a polyolefin matrix as carrier polymer, and which comprise a mixture of elemental carbon and at least one metal oxide and/or metal titanate in the core as absorbent and comprise at least one non-olefinic polymer compound as colour former, and the shell comprises at least one compatibiliser.

WO2017016645 A1 describes special composite pigments as laser additive, which can be introduced into the plastic to be marked analogously to standard industrial processes as dry pigment mixture, as liquid preparation or paste, or via a plastic- or wax-based concentrate, a so-called masterbatch.

US20210388206 A1 describes a polymer/ceramic composite in which the ceramic filler is dispersed in the polymer matrix.

The use of known laser additives, as described above, produces a useable marking, but still does not meet the requirements of the market, in particular if coloured polyamide or polyester mouldings are to be marked, in particular if they also contain flame retardants. Therefore, there continues to be a need for improved laser inscription additives or laser welding additives for polyamide or polyester plastics which lead to an improved, durable, dark, high-contrast marking with sharp edges in products made from them when irradiated by the types of laser usually used in industry. The laser additive should enable this high-contrast inscription by means of laser light at both low and high laser inscription speeds. A further aim of product development is to minimise the odours that occur during or after laser treatment, which occur, in particular, on use of sulfur-containing polymers.

It has now been found that the polymer composition described or preferably described below achieves these objects and eliminates the disadvantage from the prior art.

It has accordingly been shown that such a desired laser activity of polyamide or polyester plastics or products made therefrom with durably dark, high-contrast markings with sharp edges can be achieved if a polymer composition which has a polyamide or polyester carrier matrix and comprises polymer particles which, besides laser radiation-absorbing particles, comprise a sulfur-containing polymer which changes colour due to laser radiation, is added to the polyamide or polyester materials to be marked or welded. Owing to the synergistic effect between the two types of absorbent and the intrinsically active sulfur-containing polymer, the pale-coloured polymer composition can serve as laser additive having improved laser inscription performance in terms of contrast of the dark marking compared with the colour of the base material of the plastic to be marked, edge sharpness and speed compared with the known laser additives described above.

### SUMMARY OF THE INVENTION

The invention therefore relates firstly to a polymer composition comprising a polyamide or polyester carrier polymer matrix in which polymer particles are embedded, where the polymer particles consist of a sulfur-containing polymer matrix in which particulate oxides of titanium or particulate titanates, which may be doped in each case, and composite pigments are homogeneously embedded, where at least 80% by weight of the composite pigments, based on the total weight of the composite pigments, consist of titanium dioxide (TiO₂) and antimony-doped tin dioxide [(Sb,Sn)O₂].

The invention furthermore encompasses processes for preparing this polymer composition, the use of this polymer composition as a laser inscription additive or laser welding additive, and laser-inscribable or laser-weldable organic polymer compositions which comprise the polymer composition according to the invention.

In particular, polyamide as carrier matrix polymer for the polymer particles is able to significantly reduce the odour formation that occurs during laser marking.

### DESCRIPTION OF THE INVENTION

In the sense of the present invention, laser marking is taken to mean any type of labelling of plastics and coatings comprising these plastics on articles, which can be produced in the form of an inscription, a code, a label, a decoration or a similar visible optical change to the plastic through the action of the laser beam.

The abbreviation for polyamide is PA. The term “particles which absorb laser light” is used synonymously with “absorbent” and “absorber particles”.

The preferred supply form of the polymer composition according to the invention, as described or preferably described above below, is granules. Due to its free-flowing nature, it is a bulk material that is easy to transport and can easily be processed further. Alternatively, the supply form of the polymer composition according to the invention can also be a powder, a flowable mass or a paste.

The polymer composition according to the invention comprises a polyamide or polyester carrier polymer matrix, where the type of polyamide or polyester is not restricted. The carrier polymer matrix can be selected from homopolymers, copolymers or polymer blends of polyamide(s) or polyester(s), which can be linear or branched. The person skilled in the art is not restricted in the chemical nature of the polyamides or polyesters and is able to choose from a multiplicity of commercial products. Ideally, the type of polyamide or type of polyester of the carrier polymer matrix is selected so that it is compatible with the plastic to be laser marked.

In a preferred embodiment of the carrier polymer matrix, the polyamide or polyester has a melting temperature in the range from 160° to 250° C.

In a particularly preferred embodiment of the carrier polymer matrix, the polyamide is selected from PA6 or PA12, in particular from PA12. A particularly preferred PA12 is the commercially available product Vestamid® L1600 from Evonik Operations GmbH.

In a particularly preferred embodiment of the carrier polymer matrix, the polyester is selected from polyethylene terephthalate (PET), polyethylene terephthalate glycol (PETG) or polybutylene terephthalate (PBT).

Besides the polyamide or polyester carrier polymer matrix in which polymer particles are homogeneously embedded, the polymer composition according to the invention may, as described above or preferably described below, comprise further additives, such as, for example, adhesion promoters, stabilisers, fillers or colourants.

Suitable adhesion promoters are, for example, thermoplastic polymers carrying functional groups, which encompasses both terminal groups and also additionally introduced functional groups. These are generally graft or block copolymers. Suitable adhesion promoters are maleic anhydride-grafted polymers, e.g. Fusabond™ from Dow.

Suitable stabilisers are, for example, phenolic antioxidants, such as Irganox® 1010 and 1098, and phosphites, such as Irgafos® 168 from BASF.

Suitable fillers are, for example, various silicates, SiO₂, talc, kaolin, mica, wollastonite, glass fibres, glass beads, carbon fibres or the like.

Colourants which come into consideration are both organic dyes and inorganic or organic coloured pigments. Since the polymer composition according to the invention is very pale and can therefore be coloured readily, it is possible to use virtually all soluble dyes or insoluble coloured pigments that are suitable for polyamide or polyester. Examples which may be mentioned here are merely the particularly frequently used white pigments TiO₂, ZnO, BaSO₄ and CaCO₃. The amount and type of the added fillers and/or colourants is adequately known to the person skilled in the art and is limited merely by the respective specific material nature of the laser-inscribable or laser-weldable organic polymer composition into which the polymer composition according to the invention is to be incorporated for the purpose used.

In a preferred embodiment of the polymer composition according to the invention, it consists of the carrier polymer matrix, as described or preferably described above, in which polymer particles are embedded, where the polymer particles have a meaning as described above or preferably described below.

In a preferred embodiment of the polymer particles which are embedded in the carrier polymer matrix, as described above, the sulfur-containing polymer of the polymer matrix is selected from a polysulfone or from polyphenylene sulfide.

The polymer matrix can be selected from homopolymers, copolymers or polymer blends of polysulfone or polyphenylene sulfide, which can be linear or branched. The person skilled in the art is not limited in the chemical nature of the polysulfones or polyphenylene sulfide and is able to choose from a multiplicity of commercial products. The term “polysulfone” is used to describe the class of polymers, but also as a specific polymer in combination with the abbreviation PSU.

In a particularly preferred embodiment of the polymer matrix, the polysulfone is selected from polysulfone (PSU), polyarylene sulfone (PAS), polybisphenyl sulfone (PSF), polyether sulfone (PES) or polyphenylene sulfone (PPSU). Polysulfones are commercially available from BASF under the name Ultrason®.

In a particularly preferred embodiment of the polymer matrix for the polymer particles, polyphenylene sulfide (PPS) is selected.

PPS preferably has, as described or preferably described above, a viscosity of 200 to 600 Pas, measured at 310° C. and a shear rate of 1200 1/s in a capillary rheometer according to ISO 11443.

PPS particularly preferably has, as described or preferably described above, a viscosity of 300 to 500 Pas, measured at 310° C. and a shear rate of 1200 1/s in a capillary rheometer according to ISO 11443.

Particularly preferred commercially available products are Fortron® 0320C0 and Fortron® 1200L1 from Celanese.

In accordance with the invention, two types of particles which absorb laser light are incorporated into the polymer matrix, as described or preferably described above, and then form the polymer particles together with the polymer matrix. The first type of particles which absorb laser light are particulate oxides of titanium or particulate titanates, which may be doped in each case, and the second type are composite pigments, where at least 80% by weight of the composite pigments, based on the total weight of the composite pigments, consist of titanium dioxide (TiO₂) and antimony-doped tin dioxide ((Sb,Sn)O₂).

In general, the person skilled in the art is not restricted in the choice of particulate oxides of titanium and particulate titanates.

The particle size of the particles which absorb laser light selected from particulate oxides of titanium or particulate titanates, as described or preferably described above, is determined by the requirement that the particles must be miscible with the polymer matrix. A person skilled in the art will know that this miscibility is determined by the total surface area of a certain amount by weight of the particles which absorb laser light and that the person skilled in the art will readily be able to determine the lower limit of the particle size if the desired size of the polymer particle and the desired amount of the particles which absorb laser light to be mixed in are known.

In a particularly preferred embodiment of the polymer particles, particulate titanium dioxide, which may be doped, is incorporated into the polymer matrix as described or preferably described above.

Particulate titanium dioxide can be in the form of rutile or anatase or in amorphous form here, but preferably in the form of rutile. A preferred average particle size is in the range from 0.1 to 4 μm, particularly preferably in the range from 0.15 to 2 μm. The particulate titanium dioxide can have any conceivable shape. It is preferred if the particulate titanium dioxide has an isotropic shape. These are shapes that are more or less ideally the same in all directions of the core, viewed from an imaginary centre point, i.e. have no preferential direction. These include spherical and cubic cores as well as cores that have irregular, compact granule shapes, but also shapes of regular or semi-regular polyhedra having n surfaces (Platonic and Archimedean solids), where n is in the range from 4 to 92. It goes without saying that the terms spherical, cubic or regular also apply here to core shapes that are not ideally spherical, ideally cubic or ideally regular in the geometric sense. Since the particulate titanium dioxide is produced in industrial processes, technologically attributable deviations from the ideal geometric shape, such as rounded edges or surfaces with slightly different sizes and shapes in polyhedral bodies, are also included here.

The titanium dioxide may also be doped. In the sense of the present invention, doping is taken to mean the presence of corresponding ions in small quantities as defects in the crystal lattice of the titanium dioxide. Preferred dopings are those with iron or cerium ions. Very particular preference is given to doping of the titanium dioxide with iron ions. Particulate titanium dioxide which is suitable for incorporation into the polymer matrix in accordance with the invention can be obtained by various methods which are well known to the person skilled in the art. For example, production can be carried out via a pyrogenic process (such as, for example, by means of flame pyrolysis), by means of a sol-gel process, a plasma process by means of a hydrothermal process or by means of a combination of the various process variants.

In a further variant of the invention, however, it is preferred if the particulate titanium dioxide is undoped. Suitable particulate titanium dioxides in the stated order of magnitude are available on the market, for example under the trade names KRONOS® (KRONOS Worldwide, Inc.), HOMBITEC® (Venator) or Tipaque® (Ishihara Corp.). A particularly preferred particulate titanium dioxide is the commercially available product KRONOS® 2220 from KRONOS Worldwide Inc.

The salts or esters of titanic acids are referred to as titanates. Alternatively, they can be regarded as mixed oxides. The particulate titanates which can be employed in accordance with the invention can be of natural origin or synthetically produced. Naturally occurring titanium minerals which can be employed as particulate titanate in accordance with the invention are perovskite, barioperovskite, macedonite, ilmenite, geikielite, pyrophanite, tausonite, which can be used correspondingly purified and ground.

In a particularly preferred embodiment of the polymer particles, particulate titanates selected from aluminium titanate, bismuth titanate, copper titanate, iron titanate, magnesium titanate, potassium titanate, sodium titanate, zinc titanate, cerium titanate, calcium titanate, barium titanate or strontium titanate are incorporated into the polymer matrix, as described or preferably described above. Preferred particulate titanates are aluminium titanate (Al₂TiO₅), sodium titanate (Na₂TiO₃), potassium titanate (K₂TiO₃), zinc titanate (ZnTiO₃), calcium titanate (CaTiO₃), cerium titanate (CeTiO₄), barium titanate (BaTiO₃) or magnesium titanate (MgTiO₃). Particularly preferred particulate titanates are sodium titanate, potassium titanate, zinc titanate and magnesium titanate.

The average particle size of the particulate titanates, as described above, is preferably in the range from 0.1 to 20 μm, in particular 0.2 to 15 μm and very particularly preferably in the range from 0.5 to 10 μm.

Suitable metal titanates are, for example, 99% calcium titanate from ABCR GMBH & Co. KG (d50 max. 3.5 μm), potassium titanium oxide, magnesium titanium oxide, 99+% calcium titanium oxide from Alfa Aesar, 99.9% nano barium titanate from ABCR GmbH & Co. KG (approx. 400 nm; BET 2.3-2.7 m²/g).

In a preferred embodiment of the polymer particles, composite pigments which comprise a titanium dioxide core and at least one coating of antimony-doped tin dioxide are incorporated into the polymer matrix and besides the first type of particles which absorb laser light, as described or preferably described above, and they optionally have an outer protective layer and/or one or more intermediate layer(s) between the titanium dioxide core and the [(Sb, Sn)O₂] coating.

If a single composite pigment particle merely consists of a single core and a coating located on the core, the composite pigments employed in accordance with the invention are composed exclusively of primary particles and are therefore monodisperse. More frequent and therefore preferred, however, is the embodiment in which the composite pigments employed are agglomerates of two or more primary particles, where each primary particle has a core and a coating arranged on the core.

In accordance with the invention, it is possible to employ both composite pigments whose primary particles have a layer structure with the sequence core/functional layer, a layer structure core/intermediate layer(s)/functional layer, a layer structure core/functional layer/protective layer(s) or a layer structure core/intermediate layer(s)/functional layer/protective layer(s). The functional layer is the coating of antimony-doped tin dioxide.

The proportion by weight of the sum of core and functional layer, i.e. the sum of TiO₂ and antimony-doped tin dioxide, is in each case at least 80 wt.-%, preferably at least 90 wt.-%, and in particular 95-100 wt.-%, based on the total weight of the composite pigment.

If intermediate layers and/or protective layers are present, these consist predominantly of inorganic materials in the case of intermediate layers. Highly suitable intermediate layers are metal oxides, in particular SiO₂, SnO₂, Al₂O₃, ZnO, CaO, ZrO₂, Sb₂O₃, or mixtures thereof.

By contrast, protective layers which may be present on the surface of the composite pigments employed can be of either an inorganic or organic nature. They are generally applied if the use of the composite pigments in the application medium, i.e. here the sulfur-containing polymer matrix, is additionally simplified by a corresponding surface coating. In the case of inorganic protective layers, these are preferably ZrO₂, Ce₂O₃, Cr₂O₃, CaO, SiO₂, Al₂O₃, ZnO, TiO₂, SnO₂, Sb₂O₃, or the corresponding oxide hydrates, as well as mixtures of two or more thereof.

Organic protective layers generally consist of suitable organosilanes, organotitanates or organozirconates. Suitable substances are known to the person skilled in the art as agents for surface coating and surface post-coating of effect pigments.

The total proportion by weight of intermediate and/or protective layer(s) is at most 20 wt.-%, preferably at most 10 wt.-%, particularly preferably 0 to 5 wt.-%, based on the total weight of the composite pigment.

In a particularly preferred embodiment of the composite pigments, the composite pigments used consist only of TiO₂ and (Sb,Sn)O₂. Extremely small amounts of other components are merely possible due to the nature of the titanium dioxide used or of the antimony-doped tin dioxide (0.001 to 0.1% by weight of foreign ions).

In a preferred embodiment of the composite pigment, the antimony-doped tin dioxide coating consists of a material in which the percentage proportion by weight of antimony, relative to tin, is between 2 and 35 wt.-%, preferably from 8 to 30 wt.-%, and in particular from 10 to 20 wt.-%, based on the total weight of antimony and tin.

In a preferred embodiment of the invention, the composite pigment to be employed in accordance with the invention consists only of one or more primary particles, which are in each case composed of a core and a functional coating located on the core, i.e. of a TiO₂ core and a (Sb, Sn)O₂ coating; most preferred, however, is the embodiment in which the composite pigment consists of primary particle(s) in each case consisting of a TiO₂ core and an (Sb,Sn)O₂ coating.

The core in the composite pigments employed in accordance with the invention can have any conceivable shape. It is preferred if the core in the composite pigments has an isotropic shape. These are shapes that are more or less ideally the same in all directions of the core, viewed from an imaginary centre point, i.e. have no preferential direction, as explained above for the particulate titanium dioxides. The same statements on the shape apply correspondingly.

Since the cores of the composite pigments are produced in industrial processes, technologically attributable deviations from the ideal geometric shape, such as rounded edges or surfaces with slightly different sizes and shapes in polyhedral bodies, are also included here.

The cores in the composite pigments employed in accordance with the invention have a particle size in the range from 0.001 to 10 μm, preferably from 0.001 to 5 μm and in particular from 0.01 to 3 μm.

They consist of TiO₂, which is available on the market in the stated size range. For example, TiO₂ particles are available on the market under the trade names KRONOS® (KRONOS Worldwide, Inc.), HOMBITEC® (Venator) or Tipaque® (Ishihara Corp.).

On the surface of the cores having the above-mentioned size and material composition, the primary particles of the composite pigments employed in accordance with the invention have a coating which has a layer thickness in the range from 1 to 500 nm, preferably in the range from 1 to 200 nm.

As already explained above, the coating comprises at least one functional layer. Intermediate layer(s) or protective layer(s), if present, also count as part of the coating. The above-mentioned order of magnitude for the layer thickness of the coating applies both to the coating that consists only of a functional layer as described above and to the coating that, in addition to the functional layer, also has one or more intermediate layers and/or protective layers. Particular preference is given to a layer thickness range from 1 to 100 nm for a coating which consists only of an [(Sb,Sn)O₂] functional layer, as described or preferably described above.

The proportion of the coating is 5 to 70 wt.-%, based on the total weight of a primary particle and also 5 to 70 wt.-%, based on the total weight of the composite pigment. These data refer both to a coating that consists only of a functional layer as described above and to a coating that contains one or more intermediate layers and/or protective layers in addition to the functional layer.

In the preferred embodiment of the composite pigment having a TiO₂ core and an antimony-doped tin dioxide [(Sb,Sn)O₂] coating, the proportion of this coating is preferably in the range from 35 to 55 wt.-%, in particular in the range from 40 to 50 wt.-%, based on the total weight of a primary particle or based on the total weight of the composite pigment.

The particle size of the composite pigments employed in accordance with the invention is in the range from 0.1 to 10 μm, preferably from 0.2 to 5 μm. Particular preference is given to the use of composite pigments having particle sizes in the range from 0.1 to 1 μm with a D₉₀ value in the range from 0.70 to 0.90 μm.

All particle sizes indicated above or particle sizes indicated below can be determined using conventional methods for particle size determination. Particular preference is given to a method for particle size determination using the laser diffraction method, in which advantageously both the nominal particle size of the individual particles and also their percentage particle size distribution can be determined. All particle size determinations carried out in the present invention are determined by the laser diffraction method using a Malvern 2000 instrument from Malvern Instruments Ltd., UK, in accordance with standard conditions of ISO/DIS 13320.

The layer thickness of the respective coating is determined numerically using SEM and/or TEM images, as is generally known to the person skilled in the art.

The composite pigments employed in accordance with the invention are produced by processes known per se. In these, the titanium dioxide particles employed as cores are provided with a coating as described or preferably described above. Since these are in each case inorganic starting materials, the coating of the cores with the functional layer is preferably carried out in aqueous suspension by precipitation of the respective metal oxides or metal oxide hydrates with subsequent conversion into the metal oxides. Precursor materials for the metal oxides to be obtained, generally metal salts, are added in dissolved form to the aqueous suspension of the respective core materials and are precipitated onto the cores, usually in the form of the metal oxide hydrates, at an appropriately set pH. The metal oxide hydrates are subsequently converted into the corresponding oxides by treatment at elevated temperature. The coating of the cores with any intermediate and/or protective layers to be applied can be carried out in the same way, provided they are inorganic layers. Organic post-coating processes are also carried out by methods customary in the prior art, in particular by bringing the surfaces of the composite particles into direct contact with the corresponding organic materials in a suitable medium.

The preparation of a preferred embodiment of the composite pigment consisting of TiO₂ cores which are provided with a functional coating of antimony-doped tin dioxide is described in detail in the example part (Synthesis Example 1). A particularly preferred composite pigment which is used in accordance with the invention is commercially available under the name Iriotec® 8850 from Merck KGAA, Darmstadt.

In a preferred embodiment of the polymer particles as constituent of the polymer composition according to the invention, as described or preferably described above, the percentage proportion by weight of particulate oxide of titanium or of particulate titanate, as described or preferably described above, relative to the composite pigment, as described or preferably described above, is 50 to 99 wt.-%, based on the total weight of particulate oxide of titanium or particulate titanate and composite pigment.

In this embodiment of the polymer particles as constituent of the polymer composition according to the invention, the percentage proportion by weight of particulate oxide of titanium or of particulate titanate, as described or preferably described above, relative to the composite pigment, as described or preferably described above, is preferably 60 to 97.5 wt.-%, particularly preferably 70 to 95 wt.-%, based on the total weight of particulate oxide of titanium or particulate titanate and composite pigment.

The described particles which absorb laser light, the composition thereof and the percentage proportions by weight thereof relative to one another as described or preferably described above, are present in the sulfur-containing polymer matrix in an amount of 5 to 90 wt.-%, preferably 10 to 80 wt.-%, and in particular in an amount of 30 to 70 wt.-%, in each case based on the total weight of the sulfur-containing polymer matrix and the particles which absorb laser light that form the polymer particles.

The particle size of the polymer particles as constituent of the polymer composition according to the invention, which are formed during the preparation of the polymer composition according to the invention, is in the range from 0.5 to 50 μm, preferably from 1 to 20 μm and in particular from 2 to 10 μm.

The size of the polymer particles can be determined by an SEM/TEM investigation.

It is advantageous if the particles are significantly smaller than 50 μm, as good resolution during laser marking is thus achieved.

The production of the polymer particles is carried out in situ during the preparation of the polymer composition according to the invention. A suitable precursor for the in situ production of the polymer particles is described in the following process.

In a suitable process, firstly the particulate oxide of titanium or the particulate titanate is intimately mixed with the composite pigment with maintenance of the stated proportions by weight, as described or preferably described above, giving a mixture of solids. Any mixer, for example a tumble mixer, can be used for this purpose. The powder mixture is then mixed homogeneously together with the sulfur-containing polymer, as described or preferably described above, and in the proportions by weight described, and extruded and solidified to give the precursor. The term “extrusion” is widely known in the art and refers to the pressing out of a solidifiable mass through an opening. An extruder is used for this purpose in the present process. Extruders are also known in the art and are commercially available. The term extruder refers to a conveyor device for carrying out an extrusion. For example, single-screw or twin-screw extruders can be employed. The selection and matching of suitable extruder screws, in particular their geometries, on the basis of the corresponding process engineering tasks, such as, for example, feeding, conveying, homogenising, softening and compressing, is part of the general knowledge of the person skilled in the art.

The powder mixture of the particles which absorb laser light and the amount of sulfur-containing polymer in the form of a powder, a flowable mass and/or as granules is preferably compounded in a co-rotating twin-screw extruder, where the mixture is melted and subjected to strong shear in the extruder in order to ensure homogeneous distribution, and is subsequently extruded and solidified. It may be provided that the powder mixture of the particles which absorb laser light and the sulfur-containing polymer are added in two different feeds simultaneously or alternatively successively or successively or simultaneously in a single feed. The generation of the precursor is preferably carried out at temperatures above the melting temperature of the sulfur-containing polymer, preferably at temperatures between 280° C. and 320° C. The extrudate is typically granulated using the strand pelletising method. The mixture to be solidified is discharged from the extruder through, for example, a perforated plate. The melt strand is then cooled in a water bath and converted into granules by a rotating blade. Typical perforated plates have 1-2 mm nozzles.

In the next step, the precursor is mixed with the carrier polymer, i.e. the polyamide or polyester. The mixture is subsequently compounded again in the extruder, where in a preferred embodiment a co-rotating twin-screw extruder is again used. The processing temperature must again be above the melting temperature of the sulfur-containing polymer, preferably at temperatures between 280° C. and 320° C. The high shear in the extruder leads to the formation of polymer particles consisting of sulfur-containing polymer which comprise the two types of absorber particles, as described above. The melt is then discharged through a perforated plate and thus shaped into a strand, which in turn is converted into granules by a rotating blade in the strand pelletising process. The product formed can be used for laser marking and has the optimum properties already mentioned.

The polymer particles produced in situ, as described or preferably described above, are present in the polyamide or polyester carrier polymer matrix, as described or preferably described above, in an amount of 10 to 90 wt.-%, preferably 20 to 80 wt.-%, and in particular in an amount of 30 to 70 wt.-%, in each case based on the total weight of the polymer composition.

In the in situ production of the polymer particles, as described or preferably described above, the corresponding precursor can also be employed in mixtures with other additives known from the prior art in the polymer composition according to the invention comprising a carrier polymer matrix, as described above. In the latter case, the proportion of the precursor is reduced by the proportion of the other additive or additives. In total, the proportion of other additives in the polymer composition according to the invention is 0 to 40% by weight, particularly preferably 0.1 to 25% by weight, very particularly preferably 0 to 10% by weight. Suitable additives have already been described above.

In a preferred embodiment of the invention, the polymer composition according to the invention is a polymer composition in which each component corresponds to a preferred embodiment.

In a particularly preferred embodiment of the invention, the polymer composition comprises a polyamide carrier polymer matrix in which polymer particles are embedded, where the polymer particles consist of a polyphenylene sulfide polymer matrix in which particulate titanium dioxide, which is undoped, and composite pigments are homogeneously embedded, where the composite pigments consist of TiO₂ cores provided with a functional coating of antimony-doped tin dioxide.

In a particularly preferred embodiment of the invention, the polymer composition comprises a polyester carrier polymer matrix in which polymer particles are embedded, where the polymer particles consist of a polyphenylene sulfide polymer matrix in which particulate titanium dioxide, which is undoped, and composite pigments are homogeneously embedded, where the composite pigments consist of TiO₂ cores provided with a functional coating of antimony-doped tin dioxide.

The particularly preferred embodiments of the invention apply correspondingly to the explanation regarding the preferred polymers and components which absorb laser light and their proportions by weight relative to one another.

The invention furthermore relates, according to the explanations above, to a process for the preparation of a polymer composition, as described or preferably described above, characterised in that (i) in a first process step, the particulate oxide of titanium or the particulate titanate is intimately mixed with the composite pigment with maintenance of the stated proportions by weight, as described or preferably described above, (ii) in a second process step, this mixture of solids from (i) is intimately and homogeneously mixed with the sulfur-containing polymer to form a powder mixture, (iii) the powder mixture is plasticised and homogenised in a third process step and forms the precursor for the polymer particles to be produced in situ, and (iv) in a fourth process step, the precursor for the polymer particles to be produced in situ from step (iii) is homogeneously extruded and solidified together with a polyamide or polyester carrier polymer matrix.

Process steps (i) to (iii) can be carried out in one apparatus and process step (iv) can be carried out in a second apparatus or at a different point in time in the same apparatus. However, all process steps can also be carried out sequentially in one extruder.

Process step (i), process steps (ii) and (iii) and process step (iv) can be carried out at different times and intermediate products from these process steps can be stored appropriately until further use. Appropriate storage conditions are known to the person skilled in the art.

In a preferred embodiment of the process for the preparation of the polymer composition according to the invention, the third and/or fourth process step is melt extrusion.

The invention furthermore relates to an alternative process for the preparation of a polymer composition as described or preferably described above, characterised in that (i) the particulate oxide of titanium or the particulate titanate is metered directly into the extruder with the composite pigment and with the sulfur-containing polymer with maintenance of the stated proportions by weight as described or preferably described above, and forms the precursor for the polymer particles to be produced in situ and (ii) in a second process step, the precursor for the polymer particles to be produced in situ from step (i) is homogeneously extruded and solidified together with a polyamide or polyester carrier polymer matrix.

In a preferred embodiment of the alternative process for the preparation of the polymer composition according to the invention, both process steps are melt extrusion. Granules of the polymer composition according to the invention which have been obtained in accordance with a preferred embodiment preferably have a diameter in the range from 0.1 mm to 5 mm, preferably 2 to 3 mm, measured by means of optical methods as a numerical average. Granules preferably obtained preferably have a diameter in the range from 0.1 mm to 5 mm, preferably 2 to 3 mm, measured by the sieve method, where at least 90% of the granule particles, particularly preferably at least 99% of the granule particles, have a diameter in the range from 0.1 to 5 mm, preferably 2 to 3 mm, where the percentage stated refers to the number of particles.

In the case of non-spherical granules, the diameters mentioned above refer to the smallest dimension of the granule particles.

The invention furthermore relates to the use of a polymer composition as described above or described as preferred as a laser inscription additive or laser welding additive in organic polymer compositions.

In the sense of the invention, the term “plastic to be marked” means that an “organic polymer composition to be marked” is intended to be synonymous.

The invention furthermore relates to a laser-inscribable or laser-weldable organic polymer composition comprising a polymer composition comprising a polyamide or polyester carrier polymer matrix in which polymer particles are embedded, where the polymer particles consist of a sulfur-containing polymer matrix in which particulate oxides of titanium or particulate titanates, which may in each case be doped, and composite pigments are homogeneously embedded, where at least 80% by weight of the composite pigments, based on the total weight of the composite pigments, consist of titanium dioxide (TiO₂) and antimony-doped tin dioxide [(Sb,Sn)O₂], as described or preferably described above.

The polymer composition according to the invention comprising a polyamide carrier polymer matrix is particularly suitable for incorporation into plastics to be marked which are compatible with polyamide.

The polymer composition according to the invention containing a polyester carrier polymer matrix is particularly suitable for incorporation into plastics to be marked which are compatible with the polyester.

The incorporation of the polymer composition according to the invention as laser inscription or laser welding additive, as described or preferably described above, into the plastic to be marked is carried out by the conventional methods known to the person skilled in the art, for example by admixture and optionally by shaping under the influence of heat. For example, the preparation of an organic polymer composition to be marked is carried out by mixing an organic polymer, for example as polymer granules, with the polymer composition according to the invention as laser inscription or laser welding additive and possibly with further additives, such as adhesion promoters, stabilisers, flame retardants, fillers or colourants in a suitable mixer.

The pigmentation of the plastic is usually carried out via a colour concentrate (masterbatch) or compound.

The mixture obtained in this way can then be processed directly in an extruder or an injection moulding machine. The mouldings obtained in the case of processing of this type exhibit a very homogeneous distribution of the laser inscription or laser welding additive. The resultant extrudate can be converted further into any plastic moulding and can be marked with laser light. The mouldings produced from the injection moulding process or films or coatings on articles can subsequently be subjected to conventional marking using a suitable laser.

The addition of the laser inscription or laser welding additive to the plastic material can be carried out simultaneously or sequentially. Adhesives and stabilisers can optionally be added to the plastic material, preferably plastic granules, during incorporation of the laser additive.

The laser inscription or laser welding additive according to the invention is added in the organic polymer or plastic intended for laser marking in a proportion of 0.1 to 30 wt.-%, preferably 0.5 to 20 wt.-% and very particularly preferably 1 to 10 wt.-%, in each case based on the weight of the plastic to be marked.

The invention therefore furthermore relates to the laser-inscribable or laser-weldable organic polymer composition, characterised in that the proportion of laser inscription or laser welding additive according to the invention is 0.1 to 30 wt.-%, based on the weight of the organic polymer composition.

Solid-state lasers or fibre lasers having wavelengths of 355 nm (UV), 534 nm (green lasers) and 1064 nm or 1062 nm (NIR lasers; NIR=near infrared) are typically highly suitable for the laser marking of plastics or plastic-containing coatings on articles.

Pulsed solid-state or fibre lasers with wavelengths of 1064 nm or 1062 nm have proven to be particularly suitable, for example solid-state lasers having an emission wavelength of 1064 nm consisting of Nd: YAG or Nd: yttrium vanadate single crystals or fibre lasers having an emission wavelength of 1064/1062 nm.

The laser markings produced can be employed wherever abrasion-resistant, very dark markings with sharp edges are to be produced on pale or coloured plastic. Examples of applications, which are by no means exhaustive, are therefore control panels or fittings in the automotive and aircraft industries, in electrical engineering/electronics and machine and equipment construction; inscriptions or markings on equipment, instruments and consumer goods, such as, for example, washing machines, coffee machines, smartphones or televisions; logos, type designations or individual markings for equipment of all kinds, for containers, toys or tools and, not least, decorative labels in the advertising sector.

The present invention is intended to be explained below with reference to examples, but is not limited thereto.

### Examples

### Preparation of a Composite Pigment:

100 g of virtually spherical TiO₂ particles (Kronos 2900, product from KRONOS Inc.) having an average particle size in the range from 100-300 nm (measured by the laser diffraction method using a measuring instrument from Malvern Ltd., UK, Malvern 2000, under standard conditions) are heated to 75° C. in 2 I of demineralised water with stirring. The pH of the suspension is adjusted to a value of 2.0 using 10% hydrochloric acid. A tin-antimony chloride solution in hydrochloric acid consisting of 264.5 g of a 50% SnCl₄ solution, 60.4 g of a 35% SbCl₃ solution and 440 g of 10% hydrochloric acid is then slowly added, during which the pH of the suspension is kept constant by simultaneous slow addition of 32% sodium hydroxide solution. When the addition is complete, the mixture is stirred for a further 15 minutes. The pH is then adjusted to a value of 3.0 by addition of 32% sodium hydroxide solution and the mixture is stirred for a further 30 minutes.

The product is filtered off, washed, dried, calcined at a temperature of 500-900° C. for 30 minutes and sieved through a 50 μm sieve.

A composite pigment comprising TiO₂ and (Sb,Sn)O₂ having a particle size in the range from 0.1 to 1.7 μm with a D₅₀ value of 0.18 μm and a D₉₀ value of 0.74 μm is obtained. The composite pigment has a pale green-grey mass tone. The Sn: Sb ratio in the coating is 85:15.

### Preparation of the Laser Additive:

The following starting materials are used for the preparation of the polymer composition according to the invention and for comparative examples.

### As Absorber Particles:

A-1: Kronos® 2220-titanium dioxide from Kronos
A-2: Iriotec® 8850-composite pigment corresponding to the above example—from Merck KGaA
A-3: Iriotec 8815-antimony tin oxide from Merck KGAA
A-4: Iriotec 8820-antimony tin oxide, titanium dioxide on mica from Merck KGaA
A-5: Iriotec 8841-copper hydroxyphosphate (90%)+antimony tin oxide (10%) from Merck KGaA

In Table 1, the absorber particles to be used in each case are referred to as Absorber 1 and/or Absorber 2
As matrix polymer: M-1: Fortron® 1200L1-PPS from Celanese
As carrier polymer: T-1: Vestamid® L 1600-PA12 from Evonik
As test polymer: P-1: Ultramid® B3K-PA6 from BASF
As test pigment: PP-1: Kronos® 2220-titanium dioxide from KRONOS

### Preparation of the Precursor:

Various precursors are prepared with the aid of a twin-screw extruder (Leistritz Mikro 27, screw diameter 27 mm, length 36 D). The composition of the precursors are shown in Table 1. In the case of the use of two absorbents, a premix of the two pulverulent absorber particles and the preground matrix polymer is firstly prepared in the tumble mixer. The material is then fed into the main hopper of the extruder and extruded. The screw rotation speed is 250 rpm. The throughput for all compounds is 12 kg/h. The temperature in zone 1 to zone 10 is 290° C. and at the extruder head is likewise 290° C. The material is extruded through a perforated plate having two nozzles with a diameter of 2 mm to give a strand, cooled through a water bath and subsequently cut into cylindrical granules by a rotating blade.

TABLE 1
Preparation of the precursors for the later in situ production of the
polymer particles; proportions by weight in brackets in weight percent

| Precursor | V-1 | V-2 | V-3 | V-4 | V-5 | V-6 |
|---|---|---|---|---|---|---|
| Matrix | M-1 | M-1 | M-1 | M-1 | M-1 | M-1 |
| polymer | [50] | [50] | [50] | [50] | [50] | [50] |
| Absorber 1 | A-1 | A-1 | A-2 | A-3 | A-4 | A-5 |
| | [40] | [50] | [50] | [50] | [50] | [50] |
| Absorber 2 | A-2 | — | — | — | — | — |
| | [10] | | | | | |

Preparation of the Laser Marking Concentrate, i.e. Of Compositions Comprising Polyamide as Carrier Polymer and Polymer Particles Produced In Situ According to the Precursors of Table 1

A series of laser marking concentrates K-1 to K-6 is prepared using the same extruder (Leistritz Mikro 27, screw diameter 27 mm, length 36 D). The composition is shown in Table 2. For this purpose, precursor and carrier polymer are mixed in the tumble mixer and added via the main hopper of the extruder. The screw rotation speed is 250 revolutions per minute and the throughput is 15 kg/h. The temperature is 320° C. in zone 1 and 300° C. in zone 10 and 300° C. at the extruder head. The exiting melt is converted into granules by strand pelletisation as described above. The laser marking concentrate is referred to as “concentrate” in Table 2 and the other examples.

TABLE 2
Preparation of laser marking concentrates; proportions
by weight in brackets in weight percent

| Concentrate | K-1* | K-2 | K-3 | K-4 | K-5 | K-6 |
|---|---|---|---|---|---|---|
| Precursor | V-1 | V-2 | V-3 | V-4 | V-5 | V-6 |
| | [50] | [50] | [50] | [50] | [50] | [50] |
| Carrier | T-1 | T-1 | T-1 | T-1 | T-1 | T-1 |
| polymer | [50] | [50] | [50] | [50] | [50] | [50] |

*denotes according to the invention

### Preparation of the Laser-Markable Plastics

Laser-markable polyamides are prepared by extrusion in a twin-screw extruder (LabTech, screw diameter 16 mm, length 40 D). The composition of the laser-markable polyamides is shown in Table 3a and 3b. The laser marking concentrate from to Table 2 is mixed with the test polymer and optionally with the test pigment in the tumble mixer and the mixture is added via the main hopper of the extruder. The screw rotation speed is 400 revolutions per minute and the throughput is 4 kg/h. The temperature is 260° C. in zone 1, 250° C. in zone 10 and at the extruder head. A strand is produced via a perforated plate having a nozzle of diameter 2 mm. This is cooled in a water bath and granulated via a rotating blade.

In the case of the laser-markable plastics from Table 3a, the the respective laser marking concentrate is tested in the test polymer. The laser-markable plastics from Table 3b represent blends of carrier polymer with titanium dioxide as test pigment. The performance of the material in opaque formulations is assessed through the plastics from Table 3. This is important since the laser additive according to the invention is frequently used in opaque, highly filled systems. The laser-markable plastic is referred to as “compound” in Table 3a and Table 3b.

TABLE 3a
Preparation of laser-markable plastics; proportions
by weight in brackets in weight percent

| Compound | C-1* | C-2 | C-3 | C-4 | C-5 | C-6 |
|---|---|---|---|---|---|---|
| Concentrate | K-1 | K-2 | K-3 | K-4 | K-5 | K-6 |
| | [2] | [2] | [2] | [2] | [2] | [2] |
| Test | P-1 | P-1 | P-1 | P-1 | P-1 | P-1 |
| polymer | [98] | [98] | [98] | [98] | [98] | [98] |

*denotes according to the invention

TABLE 3b
Preparation of laser-markable plastics coloured with test pigment;
proportions by weight in brackets in weight percent

| Compound | C-7* | C-8 |
|---|---|---|
| Concentrate | K-1 | K-5 |
| | [2] | [2] |
| Test | PP-1 | PP-1 |
| pigment | [2] | [2] |
| Test | P-1 | P-1 |
| polymer | [96] | [96] |

*denotes according to the invention

The laser-markable plastics C-1 to C-8 are subsequently converted into tiles in an injection moulding process on an Arburg Allrounder 320D. The tiles have the dimension 60×90×1.5 mm and a smooth surface. The injection moulding temperatures correspond to the specifications for test polymer P-1. The heating zones are set correspondingly to 260° C. The tiles are used to check the laser marking.

### Assessment of the Laser Marking:

The laser marking is checked with the aid of a Trumpf VMc5 12 watt vanadate IR laser system. First, a so-called test grid is marked. In such a test grid, the marking speed (v [mm/s]) and frequency (f [KHz]) are varied at a prespecified power (p [%]). The focus here is set precisely on the material surface and the line spacing is a constant 50 μm. The power is constantly set at 100%. The speed is between 500 and 5000 mm/s. The frequency is between 20 and 100 KHz. Such a test grid is essentially used for the first assessment of the achievable marking contrast under optimum laser conditions. In a second step, a filled rectangle having the dimension 5 cm×3 cm is lasered onto a further tile. The laser power here is 100%. The marking speed is 3000 mm/s and the frequency is 80 KHz. The separation between the lines is 50 μm.

The laser-marked rectangular area and the colour of the tile is then measured using a Minolta CR-400 colour spectrometer in accordance with CIE Lab. The marking contrast arises from the difference between the L value of the tile colour and the L value of the marking. Particularly high values are representative of good marking contrast.

TABLE 4a
Assessment of laser-markable plastics C-1* and C-2 to C-6

| Compound | C-1* | C-2 | C-3 | C-4 | C-5 | C-6 |
|---|---|---|---|---|---|---|
| L value | 73.9 | 86.1 | 54.6 | 76.8 | 70.1 | 68.9 |
| tile | | | | | | |
| L value | 37.3 | 66.9 | 32.1 | 57.8 | 38.7 | 41.8 |
| laser marking | | | | | | |
| Marking contrast | 36.6 | 19.2 | 22.5 | 19.0 | 31.4 | 27.1 |

*denotes according to the invention

Table 4a clearly shows that only laser-markable plastic C-1 according to the invention with the polymer composition K-1 according to the invention comprising M-1, A-1, A-2 and T-1 has the desired properties. It exhibits particularly high marking contrast.

The two laser-markable plastics, each of which comprises the individual components (C-2 only A-1 and C-3 only A-2), remain significantly short of the properties of the mixture. The other comparative examples (C-4 comprising pure antimony tin oxide A-3, C-5 comprising composite pigment without titanium dioxide core A-4 and C-6 comprising copper hydroxyphosphate A-5) also come up significantly short in terms of performance.

TABLE 4b
Assessment of laser-markable plastics
C-7* and C-8 coloured with test pigment

| Compound | C-7* | C-8 |
|---|---|---|
| L value | 89.4 | 82.2 |
| tile | | |
| L value | 54.3 | 52.6 |
| laser marking | | |
| Marking contrast | 35.1 | 29.6 |

*indicates according to the invention

Table 4b clearly shows that coloured laser-markable plastic C-7 comprising laser concentrate K-1 according to the invention offers advantages with regard to the neutral colour of the test tile in combination with a very dark laser marking. This gives rise to the desired high marking contrast.

Accordingly, laser marking additive K-1 according to the invention is easier to overcolour than comparative additive K-5, which represents an important market requirement.

If a carrier polymer comprising Ultramid® B3K-PA6 from BASF is used instead of T-1, the results of the laser marking exhibit the same advantages of the concentrate according to the invention (alternative to K-1* with PA6) compared with the comparative concentrates (alternatives from K-2 to K-6 with PA6).

1. Polymer composition comprising a polyamide or polyester carrier polymer matrix in which polymer particles are embedded, where the polymer particles consist of a sulfur-containing polymer matrix in which particulate oxides of titanium or particulate titanates, which may be doped in each case, and composite pigments are homogeneously embedded, where at least 80% by weight of the composite pigments, based on the total weight of the composite pigments, consist of titanium dioxide (TiO₂) and antimony-doped tin dioxide [(Sb,Sn)O₂].

2. Polymer composition according to claim 1, characterised in that the polyamide or polyester has a melting temperature in the range from 160 to 250° C.

3. Polymer composition according to claim 1, characterised in that the polyamide is PA6 or PA12.

4. Polymer composition according to claim 1, characterised in that the polyester is polyethylene terephthalate (PET), polyethylene terephthalate glycol (PETG) or polybutylene terephthalate (PBT).

5. Polymer composition according to claim 1, characterised in that the sulfur-containing polymer is a polysulfone or a polyphenylene sulfide.

6. Polymer composition according to claim 5, characterised in that the polysulfone is selected from polysulfone (PSU), polyarylene sulfone (PAS), polybisphenyl sulfone (PSF), polyether sulfone (PES) or polyphenylene sulfone (PPSU).

7. Polymer composition according to claim 1, characterised in that the particulate oxides of titanium are particulate titanium dioxide, which may be doped.

8. Polymer composition according to claim 1, characterised in that the particulate titanates are aluminium titanate, bismuth titanate, copper titanate, iron titanate, magnesium titanate, potassium titanate, sodium titanate, zinc titanate, calcium titanate, cerium titanate, barium titanate or strontium titanate.

9. Polymer composition according to claim 1, characterised in that the composite pigments comprise a titanium dioxide core and at least one coating of antimony-doped tin dioxide and optionally have an outer protective layer and/or one or more intermediate layer(s) between the titanium dioxide core and the (Sb,Sn)O₂ coating.

10. Polymer composition according to claim 9, characterised in that the antimony-doped tin dioxide coating consists of a material in which the percentage proportion by weight of antimony, relative to tin, is between 2 and 35 wt.-%, based on the total weight of antimony and tin.

11. Polymer composition according to claim 1, characterised in that the percentage proportion by weight of particulate oxide of titanium or of particulate titanate, relative to the composite pigment, is between 50 and 99 wt.-%, based on the total weight of particulate oxide of titanium or particulate titanate and composite pigment.

12. Process for the preparation of a polymer composition according to claim 1, characterised in that (i) in a first process step, the particulate oxide of titanium or the particulate titanate is intimately mixed with the composite pigment, (ii) in a second process step, this mixture of solids from (i) is intimately and homogeneously mixed with the sulfur-containing polymer to form a powder mixture, (iii) the powder mixture is plasticised and homogenised in a third process step and forms the precursor for the polymer particles to be produced in situ, and (iv) in a fourth process step, the precursor for the polymer particles to be produced in situ from step (iii) is homogeneously extruded and solidified together with a polyamide or polyester carrier polymer matrix.

13. Process for the preparation of a polymer composition according to claim 1, characterised in that (i) the particulate oxide of titanium or the particulate titanate is metered directly into the extruder with the composite pigment and with the sulfur-containing polymer and forms the precursor for the polymer particles to be produced in situ and (ii) in a second process step, the precursor for the polymer particles to be produced in situ from step (i) is homogeneously extruded and solidified together with a polyamide or polyester carrier polymer matrix.

14. (canceled)

15. Laser-inscribable or laser-weldable organic polymer composition comprising a polymer composition according to claim 1.

16. Laser-inscribable or laser-weldable organic polymer composition according to claim 15, characterised in that the proportion of the polymer composition is 0.1 to 30 wt.-%, based on the weight of the organic polymer composition.
